(19) United States
(12) Patent Application Publication
(10) Pub. No.: US 2021/0356778 A1
(43) Pub. Date: Nov. 18, 2021

(54) SCREEN PRIVACY DEVICES WITH ANGLED POLYMER-DISPERSED LIQUID CRYSTAL CHANNELS

(71) Applicant: Hewlett-Packard Development Company, L.P., Spring, TX (US)

(72) Inventors: Hsing-Hung Hsieh, Taipei City (TW); Kuan-Ting Wu, Taipei City (TW); Ann Alejandro Villegas, Spring, TX (US)

(73) Assignee: Hewlett-Packard Development Company, L.P., Spring, TX (US)

(21) Appl. No.: 17/043,321

(22) PCT Filed: Jul. 2, 2018
(86) PCT No.: PCT/US2018/040634

§ 371 Date: Sep. 29, 2020

(51) Int. Cl. G02F 1/13; G02F 1/1334; G02F 1/1339

(52) U.S. Cl. CPC G02F 1/1323; G02F 1/13394; G02F 1/1334

(57) ABSTRACT

In one example in accordance with the present disclosure, a screen privacy device is described. The screen privacy device includes a substrate with channels having angled walls. A polymer-dispersed liquid crystal (PDLC) compound within the channels selectively alters a viewing angle of an underlying display screen. The screen privacy device also includes electrodes disposed on opposite wails of each of the channels to selectively apply a voltage potential across the PDLC compound within a corresponding channel.

### BACKGROUND

Electronic devices include display screens to present information to a user. Examples of display screens include liquid crystal displays, light-emitting diode displays, video display units, and the like. Such devices are used in many areas of professional and everyday life throughout the world. These electronic devices and corresponding display screens are used to access and display all sorts of information.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a screen privacy device with angled polymer-dispersed liquid crystal (PDLC) channels, according to an example of the principles described herein.

FIG. 2 is a diagram of a screen privacy device with angled PDLC channels, according to an example of the principles described herein.

FIG. 3 is a diagram of a screen privacy device with angled PDLC channels, according to another example of the principles described herein.

FIG. 4 is a flow chart of a method for forming a screen privacy device with angled PDLC channels, according to an example of the principles described herein.

FIGS. 5A-5E are diagrams of the formation of a screen privacy device with angled PDLC channels, according to an example of the principles described herein.

FIGS. 6A-6F are diagrams of the formation of a screen privacy device with angled PDLC channels, according to another example of the principles described herein.

FIG. 7 is a diagram of a display device with a screen privacy device with angled PDLC channels, according to an example of the principles described herein.

FIG. 8 is a diagram of a display device with a screen privacy device with angled PDLC channels, according to another example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

As described above, electronic devices are commonplace in today's society. With the continued development of these devices, their use in society will continue to increase. Electronic devices placed in public spaces for public use is one example of electronic device use that is on the rise. For example, kiosks are used in public places to deliver services to the public in general. While such electronic device usage is of great benefit to society, some characteristics limit their more widespread use.

Specifically, in some cases, the information displayed to a user may be private and confidential, intended just for a certain individual or group of individuals. For example, a hospital kiosk may present, or prompt entry of, certain confidential medical information. It may be difficult to keep such information private, for example when the electronic device is in a public area.

While specific reference has been made to use in a hospital setting, such devices may be used in other public contexts. Another such example is an automated teller machine (“ATM”) into which a user enters financial information such as an access code to the user's financial accounts. In such cases, there is a possibility that the displayed information may be seen by unauthorized people who may use the information to the disadvantage of a person or persons to whom the information pertains.

There may be other circumstances in which it is desirable to maintain privacy of the information displayed on an electronic device. For example, laptops or notebook computers may be used in crowded public areas such as airports, train stations, or other public areas. Such devices may be used for personal matters, such as writing a letter or working on professional matters that may have sensitive or otherwise confidential information. When used in these areas, there is no guarantee that such information will remain private or confidential as passersby may be able to view the electronic device display screen and ascertain the information therein. More specifically, there may be a general concern that a nearby person, such as the person in the next airplane seat, may be reading the information on the laptop or notebook computer. If the computer or other electronic device is used in this way, sensitive data may be stolen or otherwise compromised. This concern may keep many people from using a laptop computer in many instances when its use would be particularly convenient.

Accordingly, the present specification describes devices for increasing a privacy level for a display screen. Specifically, the present specification describes a screen privacy device that relies on polymer-dispersed liquid crystals (PDLCs) to increase privacy of a display screen. In a PDLC compound, liquid crystals can be either misaligned or aligned. When the liquid crystals are misaligned, light emanating from the display screen is scattered at different angles. When the liquid crystals are aligned, light emanating from the display screen is not scattered at different angles and the PDLC compound may be said to be transparent. A transparent PDLC compound allows light to pass through relatively unaltered,

Specifically, the present specification describes a screen privacy device. The screen privacy device includes a substrate with channels having angled walls. A polymer-dispersed liquid crystal (PDLC) compound is found within the channels to selectively alter a viewing angle of an underlying display screen. Electrodes are disposed on opposite walls of each of the channels to selectively apply a voltage potential across the PDLC compound within a corresponding channel.

The present specification also describes a method of forming a screen privacy device. According to the method, angled channels are formed in a substrate. A first electrode is formed on a first wall of each channel and a second electrode is formed on a second wall of each channel, which second wall is opposite the first wall. Each channel is then filled with a polymer-dispersed liquid crystal (PDLC) compound and the PDLC-filled channels are encapsulated.

The present specification also describes a display device. The display device includes at least 1) a screen to generate a visual output and 2) a screen privacy device disposed over the screen. The screen privacy device includes a substrate with channels having angled walls and a polymer-dispersed liquid crystal (PDLCs) compound within the channels to selectively reduce a viewing angle of an underlying display screen. The screen privacy device also includes a pair of electrodes disposed on opposite walls of each of the channels to selectively apply a voltage potential across the PDLC compound within a corresponding channel and a controller to pass a voltage to the pair of electrodes to selectively switch the PDLC compound between a sharing mode and a privacy mode.

In summary, using such a screen privacy device 1) provides enhanced security of private or confidential information presented on a display screen; 2) provides single-layer privacy, resulting in a thinner and more cost-effective screen privacy device; 3) provides screen privacy at a reduced power consumption level; and 4) provides an enhanced viewing angle when in a sharing mode. However, the devices disclosed herein may address other matters and deficiencies in a number of technical areas.

As used in the present specification and in the appended claims, the term “viewing area” and similar terminology refers broadly to an area wherein an individual sitting may view a corresponding portion of a display screen. A user outside of the viewing area, on account of the PDLCs being activated, cannot view the corresponding portion of the display screen.

Further, as used in the present specification and in the appended claims, the term “on” and “off” refers to whether a voltage is applied to a PDLC compound and that affects a PDLCs ability to scatter light, or let light pass through un-scattered. For example, when “on,” PDLCs increase the viewing area by simply allowing light from the display screen to pass without being scattered. When “off,” A PDLCs are in a scattering state wherein, light from an underlying display screen with large angles is scattered, which scattering makes the underlying display screen viewable in a narrower range.

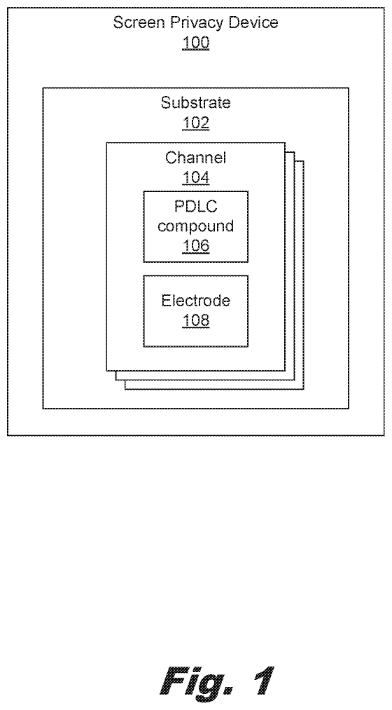

Turning now to the figures, FIG. 1 is a block diagram of a screen privacy device (100) with angled polymer-dispersed liquid crystal (PDLC) channels (104), according to an example of the principles described herein. As described above, the screen privacy device (100) may provide privacy to the user of an electronic device by altering the transmission of light through the screen privacy device (100) as it is disposed over a display screen. In this position, the screen privacy device (100) controls the viewability of the underlying display screen. In other words, the screen privacy device (100) is a privacy filter/screen that provides privacy during the use of an electronic device such as a laptop computer or other electronic device by restricting the viewing angle through which the display screen of the underlying electronic device may be viewed so that just a person sitting directly in front of the screen may read the data written on it. This angle may be reduced by placing the screen privacy device (100) across the front of the electronic device display screen, so that the electronic device display screen is viewed through the privacy device.

The selective reduction of the viewing angle of the underlying display screen is carried out by the polymer-dispersed liquid crystal (PDLC) compound (106) that is included in the screen privacy device (100). That is, the viewing angle, related to viewability of the display as a result of the screen privacy device (100), may be controlled (e.g., increased or decreased) by liquid crystals within the PDLC compound (106). For example, a PDLC compound (106) may be electronically switched between a transparent state and a light-scattering state. In the light-scattering state, the viewing angle of the screen may be reduced. This is because light from screen pixels hits the light crystals, which are misaligned, and is scattered at various angles, which generates a blurred image to viewers at wide angles. By comparison, while in a transparent state, the PDLC compound (106) increases the viewing angle of the screen. In other words, in a transparent state, light passes unaltered, thus providing a wider viewing angle for the underlying screen. By comparison, in a light-scattering state, light is scattered, thus providing more privacy. In other words, the PDLC (106) compound as described herein may offer varying levels of privacy control, specifically a transparent state (less privacy) and a light-scattering state (higher privacy).

The screen privacy device (100) includes a substrate (102). The substrate (102) may be any type of material including a plastic or a glass. The substrate (102) has a number of channels (104) that run along a dimension of the substrate (102). For example, the substrate (102) may be sized to fit over an underlying display screen. In this example, the channels (104) may run in a vertical direction, i.e., from a bottom of the display screen to a top of the display screen. In another example, the channels (104) may run in a horizontal direction, i.e., from a left side of the screen to a right side of the screen.

The channels (104) may have a trapezoidal cross-sectional shape. That is, the channels (104) may have angled walls. In some examples, the angled walls angle away from one another going farther away from the underlying display screen. In another example, the angled walls angle towards one another going away from the underlying display screen. These channels (104) may be of varying width, with a particular substrate (102) having hundreds or thousands of such channels (104). The PDLC compound (106) is disposed within these channels (104), such that the cross-sectional shape of the PDLC compound (106) within a channel (104) is also a trapezoid.

As described above, the PDLC compound (106) includes liquid crystals in a polymer matrix. When a voltage is not applied to the PDLC compound (106), the liquid crystals are not aligned with one another. However, when a voltage is applied to the PDLC compound (106), the liquid crystals align with one another. When the liquid crystals are not aligned with one another, they each reflect light in different directions, thus increasing the scattering of light from the underlying display screen. By comparison, when the liquid crystals are aligned with one another, they allow light to pass relatively unaltered.

The solid polymer matrix may be formed of any suitable material including glass or plastic. Examples of glasses that may be used as the solid polymer matrix include soda lime glass, alkali glass, boron silicate glass, non-alkali metal aluminum silicate glass, and fused silica glass, among other glasses. Examples of plastics that may be used as the solid polymer matrix include optical substrates, such as poly(methyl-methacrylate) (“PMMA”), polyethylene terephthalate (“PET”), cyclic olefin copolymer (“COG”), polycarbonate, and polyimide; transparent plastics; and transparent plastic composites.

To provide such a voltage potential across the channels (104) to effectuate the switch, electrodes (108) are disposed within the channels (104), specifically on opposite walls of the channels (104). In some examples, the opposite walls of the channel (104) on which the electrodes (108) are formed may be the angled walls of the trapezoid cross-section. In other examples, the opposite walls of the channel (104) on which the electrodes (108) are formed may be the parallel walls of the trapezoid cross-section.

As explained above, the electrodes electronically switch the PDLC compound (106) between a transparent state (“ON”) and a light-scattering state (“OFF”). When in a light-scattering state, the PDLC compound (106) alters the transmission of light such that cannot be seen from wider viewing angles. By comparison, in the transparent “ON” state, the light from the electronic display pixels may pass through the PDLC compound (106) compound relatively unchanged, providing the less private mode.

The electrodes (108) may include a transparent conductive film. The transparent conductive film may be formed of inorganic materials, organic materials, or both. Examples of inorganic material include transparent conducting oxides such as indium tin oxide, fluorine doped tin oxide, and doped zinc oxide among other transparent conducting oxides. Examples of organic materials include carbon nanotubes, graphene, poly(3,4-ethylenedioxythiophene). In one example, the electrodes (108) include at least one of In₂O₃:Sn and SnO₂:F. The conductive electrodes (108) may provide suitable electrodes for applying a voltage across the PDLC compound (106).

The electrodes (108) generate the voltage potential across the PDLC compound (106). That is, a voltage from a voltage or power source, internal to the screen privacy device (100) or external to the screen privacy device (100), supplies a voltage to the different electrodes (108). In one example, the power source may be drawn from a processor-based device. For example, direct current (“DC”) power may be provided from the battery of the electronic device, of which the display screen is a part. In another example, when the electronic device is plugged in for charging, power may be provided from the alternating current (“AC”) adapter or from the power conversion circuit within the electronic device.

The screen privacy device (100) as described herein enhances the privacy a user can expect when viewing an underlying display screen and does so in an effective manner. That is, rather than having multiple layers to provide the privacy (i.e., a louver film and a PDLC layer), the screen privacy device (100) provides privacy via a single substrate (102). Doing so results in a thinner and lighter screen privacy device (100) which is less complex to use and also to manufacture.

Moreover, in this example, the screen privacy device (100) can be placed on top of, rather than underneath the display screen or between layers of the display screen. Moreover, the screen privacy device (100) because it includes channels (104) of PDLC compound (106), provides enhanced viewing angles when in a sharing mode as compared to other privacy devices.

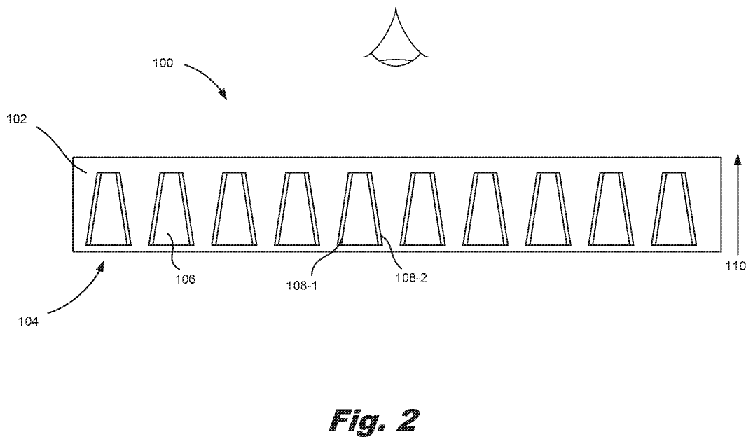

FIG. 2 is a diagram of a screen privacy device (100) with angled PDLC channels (104), according to an example of the principles described herein. Specifically, FIG. 2 is a side view wherein a display screen may be beneath the screen privacy device (100) and viewer may view the display screen from above the screen privacy device (100).

FIG. 2 clearly depicts the substrate (102) with channels (104) formed therein. For simplicity, a single channel (104) is depicted with a reference number. Moreover, for simplicity, a single reference number is used to depict the PDLC compound (106) that fills the channels (104) and a single reference number is used to depict each of a first electrode (108-1) and a second electrode (108-2). However, as described above, the screen privacy device (100) includes multiple, for example hundreds or thousands of instances of these elements across a width or height of a substrate (102) wherein the substrate (102) is to match the form factor of an underlying display screen. Note that FIG. 2 is a cross-sectional view and thus the electrodes (108-1, 108-2) may extend into the page and out of the page to the edges of the substrate (102).

As described above, the channels (104) and the PDLC compound (106) disposed therein may have cross-sections that are trapezoidal. In some examples, the longer of the parallel walls of the trapezoidal-shaped channels (104) may be closer to the display screen. That is, the angled walls of the channels (104) are angled towards each other going away from an underlying display screen as indicated by the arrow (110).

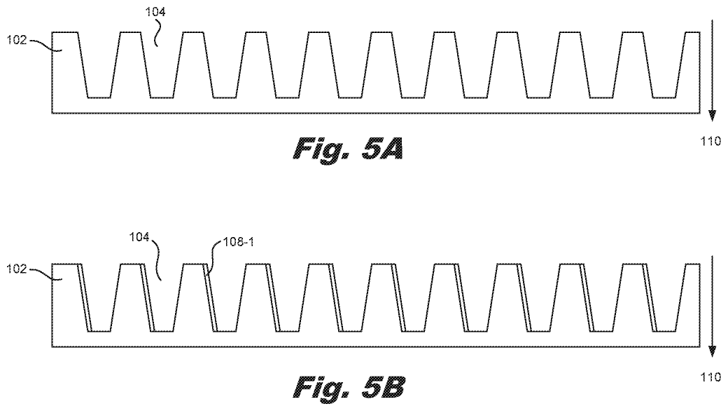

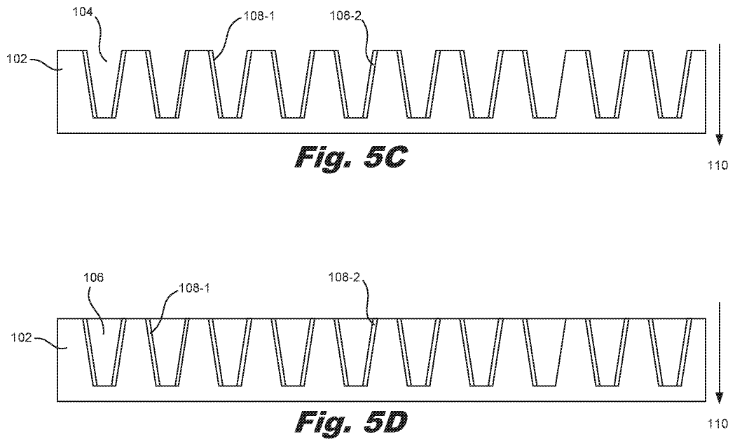

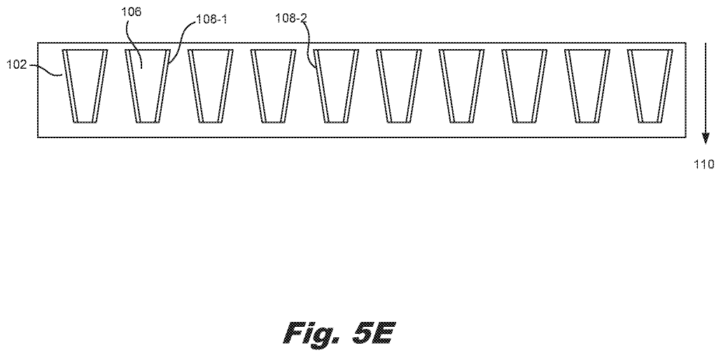

FIG. 2 also clearly depicts the electrodes (108-1, 108-2) that generate the voltage potential across the PDLC-filled channels (104). In some examples, as depicted in FIG. 2, the electrodes (108-1, 108-2) are disposed on the angled walls of the channels (104). An example method for disposing the electrodes (108) on the angled walls is provided below in connection with FIGS. 5A-5E.

When no voltage is applied to the electrodes (108), there is no voltage potential across the PDLC compound (106) disposed between the electrodes (108). With no voltage potential, the liquid crystals in the PDLC compound (106) are not oriented towards a particular direction. Thus, light emanating from the underlying display screen collides with the liquid crystals, and is scattered.

By comparison, when voltage is applied to the electrodes (108), the voltage potential generated across the PDLC compound (106) aligns the liquid crystals end-to-end between the electrodes (108). In the example depicted in FIG. 2, the liquid crystals would be aligned horizontally. With all the liquid crystals in the same orientation, light emanating from the underlying display screen collides with the liquid crystals and passes through relatively unaltered. When the liquid crystals are aligned, i.e., the PDLC compound (106) is transparent, combined with a transparent substrate (102), light passes through so all angles can be seen. By comparison, when the PDLC compound (106) is light-scattering, i.e., liquid crystals are not lighted, users in the center of the display screen can see the display through the transparent substrate (102) material, but users at large angles cannot see the display screen because light is scattered by the PDLC compound (106).

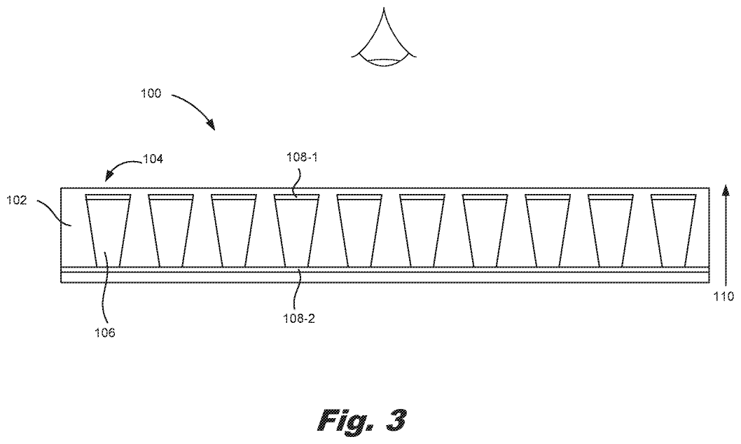

FIG. 3 is a diagram of a screen privacy device (100) with angled PDLC channels (104), according to another example of the principles described herein. In this example, the channels (104) have the same trapezoidal cross-section. However, in this example, the angled walls angle away from each other going away from the underlying display screen. That is, the angled walls of the channels (104) are angled away from each other going away from an underlying display screen as indicated by the arrow (110). Put yet another way, the short parallel wall of the trapezoidal cross-section is proximate to the underlying display screen.

FIG. 3 also depicts an example wherein the electrodes (108-1, 108-2) are formed on parallel walls of the channels (104), as opposed to the angled walls. As can be seen in FIG. 3, the parallel walls join the angled walls of the channels (104). Note that while FIG. 2 depicts 1) angled walls angling towards one another and 2) electrodes (108) disposed on angled walls and FIG. 3 depicts 1) angled walls angling away from one another and 2) electrodes disposed on parallel walls, different combinations could be achieved. For example, the angled walls may angle towards one another and the electrodes (108) may be disposed on the parallel straight walls. In yet another example, the angled walls may angle away from one another and the electrodes (108) may be disposed on the angled walls.

As described above, when no voltage is applied to the electrodes (108), there is no voltage potential across the PDLC compound (106) disposed between the electrodes (108). With no voltage potential, the liquid crystals in the PDLC compound (106) are not oriented towards a particular direction. Thus, light emanating from the underlying display screen collides with the liquid crystals, and is reflected at various angles.

By comparison, when voltage is applied to the electrodes (108), the voltage potential generated across the PDLC compound (106) aligns the liquid crystals end-to-end between the electrodes (108). In the example depicted in FIG. 3, the liquid crystals would be aligned vertically. With all the liquid crystals in the same orientation, light emanating from the underlying display screen passes through relatively unaffected. When the liquid crystals are aligned, i.e., the PDLC compound (106) is transparent, combined with a transparent substrate (102), light passes through so all angles can be seen. By comparison, when the PDLC compound (106) is light-scattering, i.e., liquid crystals are not lighted, users in the center of the display screen can see the display through the transparent substrate (102) material, but users at large angles cannot see the display screen because light is scattered by the PDLC compound (106).

Note that in this example, the second electrode (108-2) is shared among various channels (104). That is, in the example depicted in FIG. 3, each channel (104) has its own first electrode (108-1) but has a common, or shared second electrode (108-2).

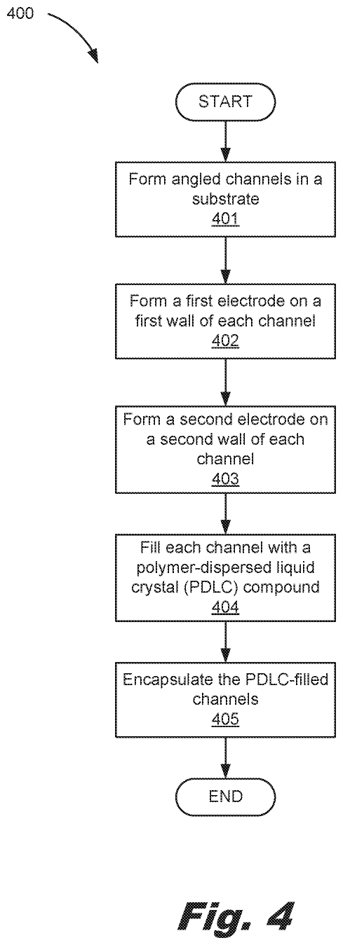

FIG. 4 is a flow chart of a method (400) for forming a screen privacy device (FIG. 1, 100) with angled PDLC channels (FIG. 1, 104), according to an example of the principles described herein. According to the method (400), angled channels (FIG. 1, 104) are formed (block 401) in a substrate (FIG. 1, 102). That is, as described above, the substrate (Fig., 1, 102) may be a rigid material such as plastic or glass that has channels (FIG. 1, 104). These channels (FIG. 1, 104) may be formed in any number of ways. For example, a mask may be placed in bands across a surface of the substrate (FIG. 1, 102). An etchant, such as a mild acid, may then be placed on top of the substrate (FIG. 1, 102). The etchant eats through exposed material while that material under the mask remains. The etchant may be placed on the substrate (FIG. 1, 102) surface for a predetermined period of time to allow formation of channels (FIG. 1, 104) having a desired depth. Other methods may be used to form (block 401) the angled channels (FIG. 1, 104). For example, a cutting device could be used to form the channels (FIG. 1, 104).

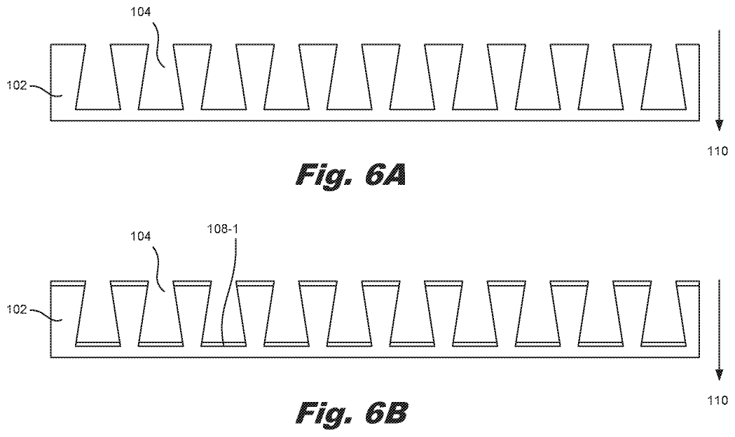

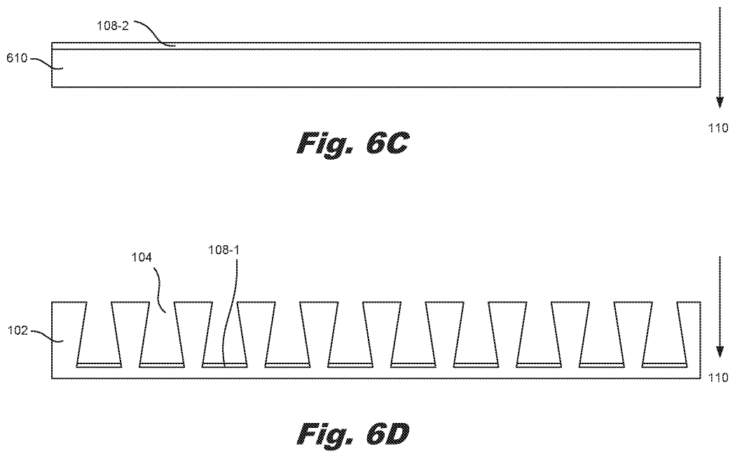

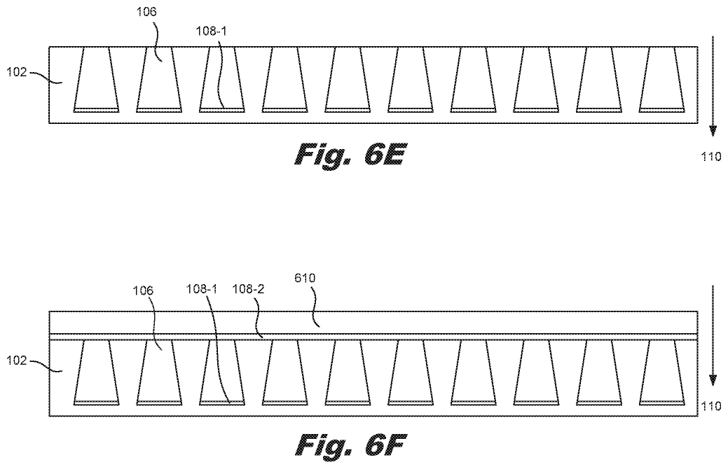

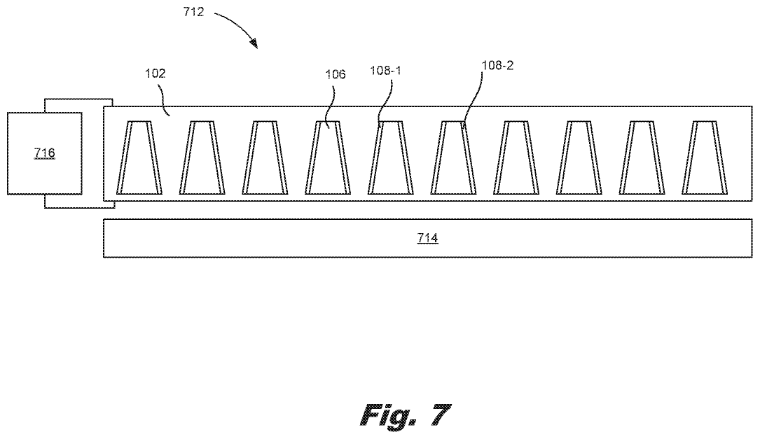

A first electrode (FIG. 1, 108) is then formed (block 402) on a first wall of each channel (FIG. 1, 104). For example, it may be deposited on a first angled wall of each channel as depicted in FIG. 5B or onto a first straight wall as depicted in FIG. 6B. In some examples, this formation (block 402) may include placing a film of a transparent electrode, such as indium tin oxide, onto the wall. The first electrode (FIG. 1, 108-1) may be formed (block 402) thereon in any number of fashions. For example, the electrode film may be deposited via sputter deposition. Other methods of depositing the electrode film may be used as well such as physical vapor deposition or electron beam evaporation.

Similarly, the second electrode (FIG. 1, 108-2) is formed (block 403) on a second wall of each channel (FIG. 1, 104) which second wall may be a second angled wall as depicted in FIG. 5C or a second straight wall on a separate substrate as depicted in FIG. 60. Similarly, the second electrode (FIG. 1, 108-2) may be formed (block 403) using any number of methods including sputter deposition and physical vapor deposition of an electrode film on the second surface.

The PDLC compound (FIG. 1, 106) is then filled (block 404) into each channel (FIG. 1, 104). In this example, the PDLC compound (FIG. 1, 106) may be in a liquid, or semi-liquid state prior to curing such that it may be poured into the channels (FIG. 1, 104). Following such a pouring, the PDLC compound (FIG. 1, 106) may be cured via an ultraviolet light for example, such that the PDLC compound (FIG. 1, 106) hardens inside the channels (FIG. 1, 104).

The PDLC-filled channels (FIG. 1, 104) are then encapsulated (block 405). Such encapsulation prevents damage, and maintains the integrity of, the PDLC compound (FIG. 1, 106), thus preserving the ability and longevity of such selective reduction of the viewing angle of an underlying display screen. Accordingly, the method (400) as described herein provides for a screen privacy device (FIG. 1, 100) that is effective, cost-effective, user-friendly and that provides a user with privacy when viewing an underlying display screen.

FIGS. 5A-5E are diagrams of the formation of a screen privacy device (FIG. 1, 100) with angled PDLC channels (104), according to an example of the principles described herein. Specifically, FIGS. 5A-5E depict the formation of a screen privacy device (FIG. 1, 100) wherein the channels (104) narrow the further away from a display screen. Note that throughout these figures, the screen privacy device (FIG. 1, 100) is shown being manufactured in an inverted state as compared to how it would be used as depicted in FIG. 2. That is, the arrow (110) indicates the direction of light travel from the display screen to a user. For simplicity in the figures that follow, a single instance of some of the components are depicted with reference numbers.

Specifically, FIG. 5A depicts a first operation wherein channels (104) are formed in the substrate (102). As described above, the substrate (102) may be a plastic or a glass material, and the channels (104) may be formed by placing a mask in bands on top of the substrate (102) and allowing an etchant to remove material.

Then, as depicted in FIG. 5B, a first electrode (108-1) is formed on a first wall, in this case a first angled wall of the channel (104). The first electrode (108-1) may be formed by depositing an electrode film on the first angled wall. Specific examples of deposition operations include physical vapor deposition and sputter deposition. In either case, as the wall is angled, the substrate (102) may be rotated such that the first angled wall is parallel to ground. The electrode film is then deposited thereon. Doing so ensures that the electrode film properly adheres to the first angled wall. Accordingly, the angle to which the substrate (102) is rotated depends on the angle of the first angled wall.

Similarly, as depicted in FIG. 5C, a second electrode (108-2) is formed on a second wall, in this case a second angled wall of the channel (104). The second electrode (108-2) may be similarly formed by depositing an electrode film on the second angled wall. Specific examples of deposition operations include physical vapor deposition and sputter deposition. In either case, as the wall is angled, the substrate (102) may be rotated such that the second angled wall is parallel to ground. The electrode film is then deposited thereon. Doing so ensures that the electrode film properly adheres to the second angled wall. Accordingly, the angle to which the substrate (102) is tilted depends on the angle of the second angled wall.

As depicted in FIG. 5D, a PDLC compound (106) is deposited into the channels (104). Before it is cured, the PDLC compound (106) may be liquid or semi-liquid such that it can be poured into the channels (FIG. 1, 104). Once in the channels (FIG. 1, 104), the entire device can be subjected to ultraviolet light, or another source of energy such that the PDLC compound (106) is hardened.

The characteristics of the ultraviolet light affect the polymerization, or hardening, of the PDLC compound (106) with different polymerizations resulting in different light-scattering properties. Accordingly, based on the application or desired level of privacy, a particular index of reflection could be selected, and a corresponding polymerization carried out by varying the characteristics of the ultraviolet light that effectuates such a polymerization.

Then as depicted in FIG. 5E, the channels (104) are encapsulated to protect the PDLC compound (106) from mechanical damage and to maintain its integrity.

FIGS. 6A-6F are diagrams of the formation of a screen privacy device (FIG. 1, 100) with angled PDLC channels (104), according to another example of the principles described herein. Specifically, FIGS. 6A-6F depict the formation of a screen privacy device (FIG. 1, 100) wherein the channels (104) widen the further away from a display screen. Note that throughout these figures, the screen privacy device (FIG. 1, 100) is shown being manufactured in an inverted state as compared to how it would be used as depicted in FIG. 3. That is, the arrow (110) indicates the direction of light travel from the display screen to a user. For simplicity in the figures that follow, a single instance of some of the components are depicted with reference numbers.

Specifically, FIG. 6A depicts a first operation wherein channels (104) are formed in the substrate (102). As described above, the substrate (102) may be a plastic or a glass material, and the channels (104) may be formed by placing a mask in bands on top of the substrate (102) and allowing an etchant to remove material.

Then, as depicted in FIG. 6B, a first electrode (108-1) is formed on a first wall, in this case a first parallel wall of the channel (104). The first electrode (108-1) may be formed by depositing an electrode film on the first parallel wall. Specific examples of deposition operations include physical vapor deposition and sputter deposition.

As depicted in FIG. 6C, a second electrode (108-2) is formed on a second wall, however, in this case the second wall is a separate substrate (610). As with the first substrate (FIG. 1, 102), the separate substrate (610) may be formed of glass or plastic. The second electrode (108-2) may be similarly formed by depositing an electrode film on the wall. Specific examples of such deposition include physical vapor deposition and sputter deposition.

Returning to the first substrate (102), as depicted in FIG. 6D, the electrode film that is formed on the attachment point between the substrate (102) and the separate piece of substrate (610) may be removed such that the two halves may be joined together.

As depicted in FIG. 6E, a PDLC compound (106) is deposited into the channels (104). Before it is cured, the PDLC compound (106) may be liquid or semi-liquid such that it can be poured into the channels (FIG. 1, 104). Once in the channels (FIG. 1, 104), the entire device can be subjected to ultraviolet light, or another source of energy such that the PDLC compound (106) is hardened.

The characteristics of the ultraviolet light affect the polymerization, or hardening, of the PDLC compound (106) with different polymerizations resulting in different light-scattering properties. Accordingly, based on the application or desired level of privacy, a particular index of reflection could be selected, and a corresponding polymerization carried out by varying the characteristics of the ultraviolet light that effectuates such a polymerization.

Then, as depicted in FIG. 6F, the substrate (102) and the separate substrate (610) are joined together thus encapsulating the PDLC-filled channels (FIG. 1, 104) to protect the PDLC compound (106) damage and to maintain its light-scattering properties.

FIG. 7 is a diagram of a display device (712) with a screen privacy device (FIG. 1, 100) with angled PDLC channels (FIG. 1, 104), according to an example of the principles described herein. To generate a visual output, the display device (712) includes a screen (714). The screen (714) may include any device, or component thereof, that permits transmission and output of information electronically to a user (e.g., viewer). The information may be visual or audio, among other formats of information presentation. In one example, the screen (714) has the capability of displaying at least visual signals. In one example, the screen (714) is an electronic visual display. The screen (714) may be a part of an electronic device. As used in the present specification and in the appended claims, an electronic device herein may refer to any device that includes an electrical circuit. The electronic device may be a consumer electronic device. Examples of electronic devices include portable/mobile electronic devices, a television, a computer, a desktop computer, a laptop, a tablet, and a gaming device among other electronic devices. A display screen of an electronic device may refer to a monitor, a liquid crystal display (“LCD”), an organic light-emitting diode (“OLED”) display, a polymer light-emitting diode (“PLED”) display , a plasma display, an electrowetting display, and a bi-stable display. Examples of bi-stable displays include electrophoretic displays, cholesteric liquid crystal displays and MEMS-based displays. Other types of electronic displays are also possible.

Disposed on top of the screen (714) is the screen privacy device (FIG. 1, 100) as described herein with a substrate (102), PDLC compound (106) disposed in channels (FIG. 1, 104), and electrodes (108) also disposed in the channels (FIG. 1, 104). As described above, the electrodes (108) generate a voltage potential across the PDLC compound (106). Accordingly, the display device (712) includes a controller (716) to pass the voltage to the pair of electrodes (108) to selectively switch the PDLC compound (106) between a sharing mode and a privacy mode. That is, when no voltage is applied, the screen privacy device (FIG. 1, 100) may be said to be in a privacy mode wherein liquid crystals are not aligned and scatter the light emanating from the screen (714) in a multitude of directions. By comparison, the controller (716) may selective generate a voltage potential between the electrodes (108) by, for example passing a first voltage to one electrode (108-1) while holding the other electrode (108-2) to ground. Such a voltage potential places the screen privacy device (FIG. 1, 100) in a sharing mode wherein liquid crystals are aligned and allowing all light to pass unaltered.

In some examples, different voltages may set the PDLC compound (106) to varying degrees of transparency. For example, a voltage of one value may set the PDLC compound (106) to a state that is more transparent and a voltage of a second value may set the PDLC compound (106) to a state that is less transparent. Put another way, a voltage of one value may effectuate greater privacy control by setting the liquid crystals to a particular tilt angle and a voltage of a different value may effectuate lesser privacy control by setting the liquid crystals to a different tilt angle that affords a different degree of privacy control.

In the example depicted in FIG. 7, the channels (FIG. 1, 104) are trapezoidal with a longer wall adjacent the screen (714) and the electrodes (108) on the angled walls. However, in other examples the shorter wall of the channels (FIG. 1, 104) may be adjacent the screen (714) and/or the electrodes (108) may be on the straight walls.

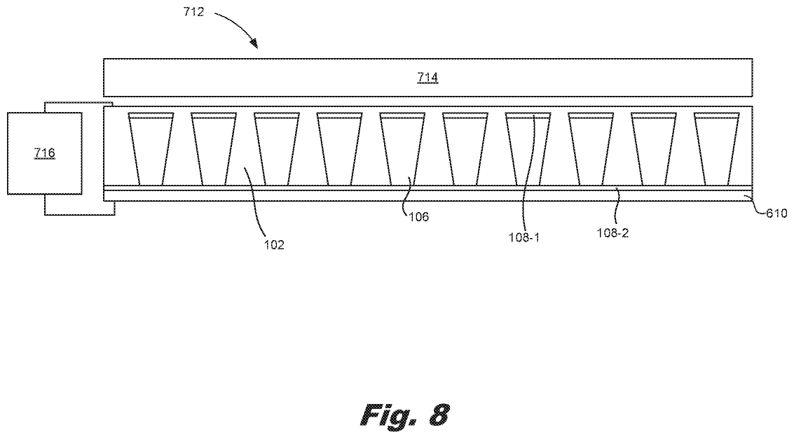

FIG. 8 is a diagram of a display device (712) with a screen privacy device (FIG. 1, 100) with angled PDLC channels (FIG. 1, 104), according to another example of the principles described herein. In this example, the display device (712) includes the screen (714) and screen privacy device (FIG. 1, 100) disposed thereon with its substrate (102), separate substrate (610), PDLC compound (106) disposed in channels (FIG. 1, 104), and electrodes (108) also disposed in the channels (FIG. 1, 104). The display device (712) also includes the controller (716) that passes the voltage to the pair of electrodes (108-1, 108-2) to selectively switch the screen privacy device (FIG. 1, 100) between a sharing mode and a privacy mode. FIG. 8 also depicts the screen (714) on top of the screen privacy device (FIG. 1, 100).

In the example depicted in FIG. 8, the channels (FIG. 1, 104) are trapezoidal with 1) a shorter wall adjacent the screen (714) and the 2) electrodes (108) on the straight walls of the channels (FIG. 1, 104). However, in other examples the longer wall of the channels (FIG. 1, 104) may be adjacent the screen (714) and/or the electrodes (108) may be on the angled walls.

In summary, using such a screen privacy device 1) provides enhanced security of private or confidential information presented on a display screen; 2) provides single-layer privacy, resulting in a thinner and more cost-effective screen privacy device; 3) provides screen privacy at a reduced power consumption level; and 4) provides an enhanced viewing angle when in a sharing mode. However, the devices disclosed herein may address other matters and deficiencies in a number of technical areas.

What is claimed is:

1. A screen privacy device, comprising:
a substrate with channels having angled walls;
a polymer-dispersed liquid crystal (PDLC) compound within the channels to selectively alter a viewing angle of an underlying display screen; and
electrodes disposed on opposite walls of each of the channels to selectively apply a voltage potential across the PDLC compound within a corresponding channel.

2. The device of claim 1, wherein the angled walls are angled towards each other going away from a display screen.

3. The device of claim 1, wherein the angled walls are angled away from each other going away from a display screen.

4. The device of claim 1, wherein the electrodes are disposed on the angled walls of the channels.

5. The device of claim 1, wherein the electrodes are disposed on parallel walls of the channels, which parallel walls join the angled walls.

6. The device of claim 1, wherein when a voltage is not applied to the PDLC compound, liquid crystals in the PDLC compound are not aligned with one another.

7. The device of claim 6, wherein when a voltage is applied to the PDLC compound, liquid crystals in the PDLC compound are aligned with one another.

8. A method, comprising:
forming angled channels in a substrate;
forming a first electrode on a first wall of each channel;
forming a second electrode on a second wall of each channel, which second wall is opposite the first wall;
filling each channel with a polymer-dispersed liquid crystal (PDLC) compound; and
encapsulating the PDLC-filled channels.

9. The method of claim 8, wherein:
forming the first electrode on the first wall comprises depositing an electrode film on a first angled wall of each channel; and
forming the second electrode on the second wall comprises depositing an electrode film on a second angled wall of each channel.

10. The method of claim 9, wherein:
forming the first electrode onto the first angled wall of each channel comprises:
rotating the substrate until the first angled wall is parallel to ground; and
depositing the electrode film on the first angled wall of each channel; and
forming the second electrode onto the second angled wall of each channel comprises:
rotating the substrate until the second angled wall is parallel to ground; and
depositing the electrode film on the second angled wall of each channel.

11. The method of claim 8, wherein:
forming the first electrode on the first wall comprises depositing an electrode film on a first parallel wall of each channel;
the second wall is on a separate substrate; and
encapsulating the PDLC-filled channels comprises attaching the substrate to the separate substrate.

12. The method of claim 11, further comprising, removing the electrode film from attachment points between the substrate and the separate substrate.

13. A display device comprising:
a screen to generate a visual output; and
a screen privacy device disposed over the screen, the screen privacy device comprising:
a substrate with channels having angled walls;
a polymer-dispersed liquid crystal (PDLC) compound within the channels to selectively alter a viewing angle of the screen; and
a pair of electrodes disposed on opposites walls of each of the channels to selectively apply a voltage potential across the PDLC compound within a corresponding channel; and
a controller to pass a voltage to the pair of electrodes to selectively switch the PDLC compound between a first mode and a second mode.

14. The device of claim 13, wherein the channels are trapezoidal with a shorter wall of parallel walls adjacent the screen.

15. The device of claim 13, wherein the channels are trapezoidal with a longer wall of parallel walls adjacent the screen.
